(19) United States
(12) Patent Application Publication
(10) Pub. No.: US 2019/0162989 A1
(43) Pub. Date: May 30, 2019

(54) THERMALLY AND ELECTRICALLY SWITCHED WINDOWS FOR COMBINED VISIBLE AND INFRARED LIGHT ATTENUATION

(71) Applicant: RavenBrick LLC, Denver, CO (US)

(72) Inventors: Wilder IGLESIAS, Denver, CO (US); Piotr POPOV, Denver, CO (US)

(21) Appl. No.: 15/823,401

(22) Filed: Nov. 27, 2017

(51) Int. Cl. G02F 1/137; G02F 1/1337; G02F 1/1339; G02F 1/1335; G02F 1/13363; E06B 9/24; B32B 17/06

(52) U.S. Cl. CPC G02F 1/137; B32B 2307/42; G02F 1/13392; G02F 1/133528; G02F 1/13363; E06B 9/24; B32B 17/06; G02F 2202/043; G02F 2203/055; G02F 2203/11; G02F 2001/133633; G02F 2001/133638; G02F 2413/01; E06B 2009/2417; E06B 2009/2464; B32B 2457/202; B32B 2307/412; G02F 1/1337

(57) ABSTRACT

Thermally and electrically driven dynamic filters for smart windows are configured to filter electromagnetic radiation in the infrared range of wavelengths. Some thermochromic filters embodiments are configured to filter both electromagnetic radiation in the infrared range of wavelengths and electromagnetic radiation in the visible range of wavelengths.

### TECHNICAL FIELD

The present disclosure is generally directed to thermally and electrically driven dynamic filters for smart windows.

### BACKGROUND

Generally, smart windows are devices capable of controlling energy and/or light passage to the interior of a building. By controlling energy and/or light passage in this way, smart windows may increase the energy efficiency of a building. Currently, smart window designs focus on modulating sunlight in the visible spectral region. Existing smart windows primarily focus on managing the amount of visible light that passes through them dynamically, either on demand or due to a predetermined physical response. To date, smart window applications manage infrared radiation by rejecting it statically, i.e., by using continuous metallic coatings to create low-emissivity (low-E) glass.

### BRIEF DESCRIPTION OF THE DRAWINGS

FIG. 1 is a graphical representation of the solar radiation spectrum through an atmosphere with an air mass coefficient of 1.0.

FIG. 2 is a schematic illustration of a filter assembly embodiment that implements dynamic control of solar infrared (IR) light using cholesteric Bragg reflectors.

FIG. 3 is a graphical representation of light transmittance through the filter assembly illustrated in FIG. 2.

FIG. 4 is a graphical representation of solar spectrum modulation through the filter assembly illustrated in FIG. 2.

FIG. 5 is a schematic illustration of a filter assembly embodiment that includes cholesteric Bragg reflectors for electrically driven modulation of light in the infrared range of the solar spectrum.

FIG. 6 is a schematic illustration of a filter assembly embodiment that integrates infrared and visible (Vis) dynamic filters into a single Vis-IR filter.

FIG. 7 is a schematic illustration of another filter assembly embodiment that integrates infrared and visible dynamic filters into a single Vis-IR filter.

FIG. 8 is a schematic illustration of another filter assembly embodiment that integrates infrared and visible dynamic filters into a single Vis-IR filter.

FIG. 9 is a schematic illustration of another filter assembly embodiment that integrates infrared and visible dynamic filters into a single Vis-IR filter.

### DETAILED DESCRIPTION

The present disclosure is generally directed to dynamic thermochromic filters for smart windows. Thermochromic filters in accordance with the present disclosure are configured to filter electromagnetic radiation in the infrared range of wavelengths. Some thermochromic filters embodiments are configured to filter both electromagnetic radiation in the infrared range of wavelengths and electromagnetic radiation in the visible range of wavelengths.

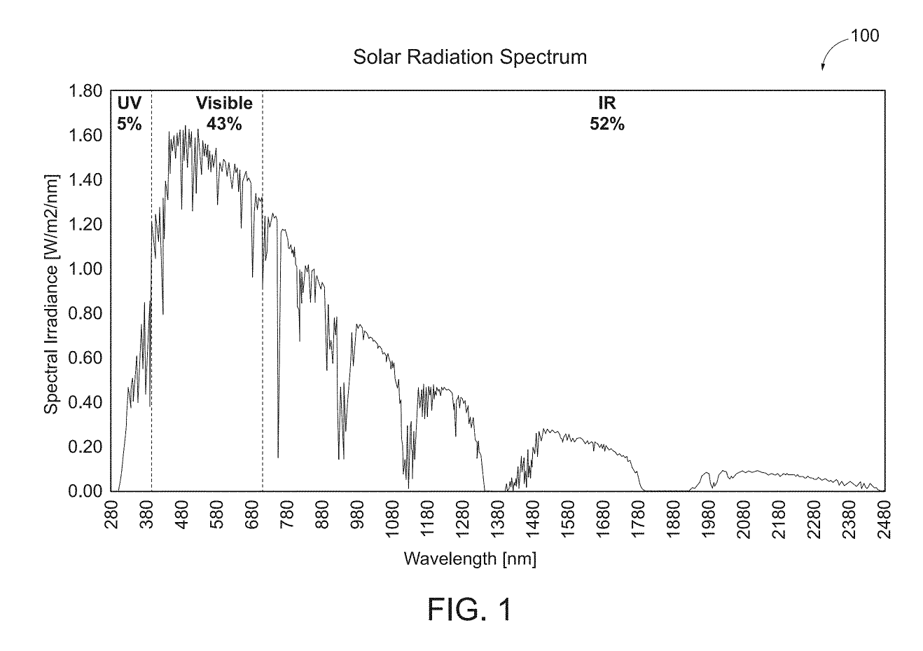

FIG. 1 is a graphical representation 100 of the solar radiation spectrum through an atmosphere with an air mass coefficient of 1.0, i.e., within tropical latitudes. As can be seen in FIG. 1, the energy of sunlight is distributed across ultra-violet (UV), visible and infrared spectral regions of electromagnetic radiation. The ultra-violet region can be further broken down into the UVA and UVB regions. The UVA regions spans from 315 nm to 380 nm. The UVB region is generally recognized to span between 280 nm to 315 nm. The visible region is generally recognized to span from 380 nm to 700 nm. The infrared region can be further broken down into the IRA and IRB regions. The IRA region is generally recognized to span from 700 nm to 1400 nm. The IRB region is generally recognized to span from 1400 nm to 3000 nm. As indicated in FIG. 1, the sunlight energy is generally distributed as follows: ˜5% in the ultra-violet region, ˜43% in the visible region and ˜52% in the infrared region in an atmosphere with an air mass coefficient of 1.0. However, the ratio of infrared radiation to visible radiation for sunlight decreases with an increasing air mass coefficient which rises across higher latitudes north and south.

Generally, smart windows are devices capable of controlling energy and/or light passage to the interior of a building. By controlling energy and/or light passage in this way, smart windows may increase the energy efficiency of a building. Currently, smart window designs focus on modulating sunlight in the visible spectral region. The energy in the ultra-violet portion of the solar spectrum is negligible (only about 5%) compared to Vis-IR regions. Nevertheless, energy in the ultra-violet portion of the solar spectrum is harmful to furniture and occupants inside the buildings as well as to functional components of the smart window. Thus, smart window designs are generally configured to completely reject ultra-violet light at all times.

Existing smart windows are primarily focused on managing the amount of visible light that passes through them dynamically, either on demand or due to a predetermined physical response. Examples of smart windows that operate on an on-demand basis include electrochromic, gasochromic, and others. Examples of smart windows that operate based on a predetermined physical response include thermochromic and photochromic.

Visible light modulation through smart windows provides benefits of control of energy efficiency and mitigation of glare in buildings with such smart windows. In order to increase the energy efficiency of smart windows, it is highly desirable to also add the capability of infrared dynamic light modulation, since infrared solar radiation delivers a significant portion (approximately 50%) of total solar radiation energy. To date, smart window applications manage infrared solar energy by rejecting it statically, e.g., by continuously using metallic coatings or low-emissivity (low-E) glass.

Sunlight energy in the infrared region spans a much wider wavelength range (780 nm to 2580 nm as shown in FIGS. 1A and 1B) than the visible spectrum region (380 nm to 780 nm). For this reason it is technically much more difficult to design a smart window with such broad band of coverage. The IRA spectral region (spanning from 780 nm to 1280 nm as shown in FIGS. 1A and 1B) accounts for the majority (specifically ⅘ or 80%) of the total infrared energy coming from the sun. Thus, control on the IRA spectral region simplifies the technical challenge to a bandwidth comparable to the visible range. Often, due to limitations of fundamental physics or due to technical difficulties, it is challenging to translate the same technology that is already developed for dynamic control of visible light to dynamic control of infrared light. The present disclosure is directed to filters that implement dynamic infrared solar energy control. Some embodiments incorporate dynamic infrared solar energy control with current dynamic visible light control for smart window applications.

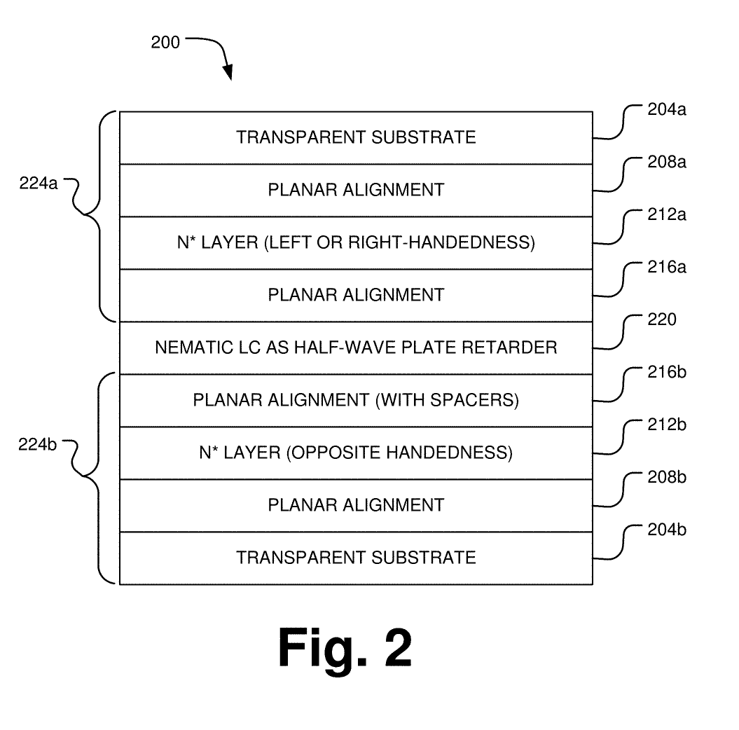

FIG. 2 is a schematic illustration of a filter assembly 200 that implements dynamic control of solar infrared light using cholesteric Bragg reflectors. In one example, the filter 200 provides a broad-band infrared (e.g., ˜780 nm to ˜1280 nm or more) smart window filter that is made by employing polymerizable chiral nematic (N*) liquid crystal (or PCNLC) coatings. The filter assembly 200 may include a transparent substrate 204a. The transparent substrate 204a may function as a mechanical carrier for additional layers of the filter assembly 200. More specifically, adjacent layers of the filter assembly 200 may be bonded, adhered, laminated, or otherwise affixed to or coupled with the transparent substrate 204a or other adjacent layers. As shown in FIG. 2, the filter assembly 200 may form a stack such that a first layer is directly affixed to the transparent substrate 204a. Additional layers may be indirectly coupled to the transparent substrate 204a through the first layer, which directly couples to the transparent substrate 204a. In one embodiment, the transparent substrate 204a is a glass pane of a window (e.g., for a building or house) such that the filter assembly 200 functions to filter solar radiation that enters the building through the window. The transparent substrate 204a may also be a vehicle window, or the like.

The filter assembly 200 may include a first liquid crystal alignment layer 208a. As shown in FIG. 2, the first liquid crystal alignment layer 208a may be arranged adjacent to the transparent substrate 204a. In this way, the first liquid crystal alignment layer 208a forms the first layer of the filter assembly 200 that is directly coupled to the transparent substrate 204a, e.g., by adhesion or lamination. The first liquid crystal alignment layer 208a may provide homogenous alignment to liquid crystals. As shown in FIG. 2 and described below, a liquid crystal layer may be coupled to the first liquid crystal alignment layer 208a on an opposite side from that side of the liquid crystal layer 208a that couples to the transparent substrate 204a. In some embodiments, the first liquid crystal alignment layer 208a may be a buffed or stretched transparent polymer film to obtain a particular planar orientation of the liquid crystal molecules that are aligned by the alignment layer 208a.

The filter assembly 200 may also include a polymerizable chiral nematic liquid crystal (N*) layer (PCNLC) 212a. As mentioned, the liquid crystal layer 212a may be positioned adjacent to the first liquid crystal alignment layer 208a on a side opposite from the side of the first liquid crystal alignment layer 208a that couples to the transparent substrate 204a. The PCNLC layer 212a may be formed of one or multiple chiral nematic liquid crystal (N*) layer(s) with chirality set to either left- or right-handedness. The PCNLC may be applied as a coating on the liquid crystal alignment layer 208a and thereby form the layer 212a. As noted, multiple coatings may be provided to form multiple sub-layers to the layer 212a. The PCNLC layer 212a is polymerized in order to preserve its chiral nematic state and pitch at working temperatures.

For the purposes of this disclosure, the term “working temperature” refers to an ambient temperature or environmental temperature in which the filter 200 operates and by which the filter 200 is affected and actuated. As the primary purpose if the filter 200 is for use in windows, the working temperature will be within typical ambient or environmental temperature ranges of the planet Earth where humans live plus the incident solar radiation on the window, i.e., between −30° C. and 80° C. In most instances, the clearing point will be within a temperature range that will affect the comfort of human beings within a building or dwelling, i.e., the goal is to attenuate or block heat transmission from sunlight into a building or dwelling when the additional transfer of heat would make the interior temperature of the building or dwelling uncomfortable for humans. Such clearing point temperatures may likely be between 15° C. and 45° C.

The pitch of the chiral nematic LC determines the reflection wavelengths and the birefringence of the chiral nematic LC determines how broad the reflection peak is. The chiral nematic LC may have a pitch gradient to reflect the desired wavelength range or multiple layers of LC with slightly different pitches may be created as described above. The polymer is then activated to hold or “freeze” these layers in place to resist temperature effects.

The filter assembly 200 may also include a second liquid crystal alignment layer 216a. As shown in FIG. 2, the second liquid crystal layer alignment layer 216a may be arranged adjacent to the PCNLC layer 212a. The second liquid crystal alignment layer 216a may provide homogenous alignment to liquid crystals on an opposite side of the PCNLC layer 212a from the side of the first liquid crystal alignment layer 208a. In some embodiments, the second liquid crystal alignment layer 216a may be a buffed or stretched transparent polymer film to obtain a particular planar orientation of the chiral nematic liquid crystal molecules in the layer 212a that are aligned by the second liquid crystal alignment layer 216a.

The filter assembly 200 may also include an inner nematic liquid crystal (or NLC) layer 220. The inner NLC may be a eutectic mixture of several NLCs in order to create a desired clearing point. The NLC layer 220 may be positioned adjacent to the second liquid crystal alignment layer 216a on a side opposite from the side of the second liquid crystal alignment layer 216a that is adjacent to the PCNLC layer 212a. The NLC layer 220 may have a nematic-isotropic clearing point that is chosen to be within the working temperature of the filter 200 such that the inner NLC layer is thermally driven. The NLC layer is used as a half-wave retarder to switch handedness of the circular polarization. The control of the retardation is achieved by controlling the thickness of the thermally driven NLC layer. The thermally driven NLC layer changes the handedness of the circular polarization in the nematic phase and leaves it unchanged in the isotropic phase (past the clearing point).

Microspheres acting as spacers may be used to define a cell gap of the NLC layer 220. The spacing may be chosen according to the birefringence and central wavelength of the reflection band (i.e., the infrared bandwidth) such that the liquid crystal layer 220 acts as a half wave retarder. In one embodiment, the liquid crystal layer 220 acts as a half wave retarder of the m=0 order according to the formula Γ=2π·Δn·d/λ=(2m+1)π, where Γ is the retardation, Δn is the birefringence value, d is the cell gap spacing, λ is the wavelength of light and m is the order of the half-wave plate and assumes integer values. Thus cell gap can be determined by d=λ/2·Δn. Higher orders of m can be used as well, but at m=0 the half wave-plate provides the polarization inversion property at the widest span of wavelengths. The microspheres can be sprayed over or embedded on one of the alignment layers 216a-b for the inner NLC layer 220. Other spacing structures may also be used, for example, microcylinders, protrusions formed on and extending from sides of substrates or alignment layers (e.g., photospacers or lithographic pillars).

The filter assembly 200 may be arranged such that the four layers described above and identified by reference numbers 204a, 208a, 212a, and 216a form a first section 224a of the filter assembly 200. The first section 224a is positioned adjacent to a first side of the inner NLC layer 220. The filter assembly 200 may additionally include a second section 224b adhered, laminated, or otherwise coupled to a second side of the inner NLC layer 220. The second section 224b may have a construction similar to that of the first section 224a. Specifically, the second section 224a may include a second transparent substrate 204b, a third liquid crystal alignment layer 208b, a second PCNLC layer 212b, and a fourth liquid crystal alignment layer 216b.

The layers of the second section 224b may be similar to the corresponding layers of the first section 224a. The second transparent substrate 204b may function as a mechanical carrier for additional layers and may form a second pane of the window of a building, vehicle, or the like. The third liquid crystal alignment layer 208b may be a transparent polymer film affixed to the transparent substrate 204b and may be buffed or stretched to obtain a particular planar orientation of the chiral liquid crystal molecules that are aligned by the alignment layer 208a. The second PCNLC layer 212b may be layered adjacent to the liquid crystal alignment layer 208b and polymerized in order to preserve its chiral nematic state and pitch at working temperatures. The fourth liquid crystal alignment layer 216b may be positioned adjacent to the second PCNLC layer 212b, may provide homogenous alignment to the chiral nematic liquid crystal molecules, and may be buffed or stretched to provide a particular planar orientation to the PCNLC layer 212b and an unidirectional planar orientation to the NLC layer 220 that are aligned by the fourth alignment layer 216b.

The layers of the second section 224b may differ from the corresponding layers of the first section 224a in some respects. These differences may serve to provide certain functionality for the filter assembly 200. For example, the PCNLC layer 212a of the first section 224a may be of opposite handedness from that of the PCNLC layer 212b of the second section 224b. Thus, if the PCNLC layer 212a of the first section 224a is selected or arranged in a right-handed configuration, the PCNLC layer 212b of the second section 224b may be selected or arranged in a left-handed configuration. Similarly, if the PCNLC layer 212a of the first section 224a is selected or arranged in a left-handed configuration, the PCNLC layer 212b of the second section 224b may be selected or arranged in a right-handed configuration.

The operation of the filter assembly 200 will now be described. Assuming that the PCNLC layer 212a (i.e., cholesteric Bragg reflector) of the first section 224a is left-handed, half of the incident infrared light is reflected or otherwise blocked as left-handed, circularly polarized light. The other half is transmitted as right-handed, circularly polarized light into the NLC layer 220, which acts as a half-wave plate. Visible light is transmitted through the PCNLC layer 212a substantially unimpeded because the bandwidth is not affected by the pitch of the the PCNLC. The half-wave plate inverts the transmitted infrared light into left-handed, circular polarized light, which is then transmitted through the second PCNLC layer 212b of the second section 224b, which is right-handed. When the temperature of filter assembly 200 rises above the clearing point of the NLC layer 220 and the NLC transitions to its isotropic state, the half-wave plate function vanishes. In this state, the transmitted right-handed, circularly polarized infrared light is no longer transformed into left-handed, circularly polarized infrared light and is thus reflected or otherwise blocked by the second PCNLC layer 212b of the second section 224b, and no longer transmitted.

The center of the infrared bandwidth λ_{center} of the circularly polarized light is determined by the following:

$${λ}_{center} = p \cdot \frac{{n}_{0} + {n}_{e}}{2} \qquad ( 1 )$$

The band gap width w is determined by the following:

w=p·(nₑ−n₀) (2)

In Equations (1) and (2), p is the pitch of the respective PCNLC 212a, 212b, n₀ is the ordinary refractive index of the respective cholesteric liquid crystal layer 212a, 212b, and nₑ is the extraordinary refractive index of the respective PCNLC 212a, 212b. The position of the center of the infrared bandwidth affected by the filter assembly 200 is controlled by the type and amount of chiral dopants in the PCNLC formulation. The helical twisting power HTP of the chiral dopant and its concentration c, which may be from 0 to 99% by weight, determines resulting cholesteric pitch according to the formula:

$$p = \frac{1}{HTP \cdot c} or p = \frac{100 \%}{HTP \cdot c} .$$

For example, a left-handed chiral dopant S811 available from Merck KGaA under code name ZLI-0811 has an HTP of 11 μm⁻¹ in an E7 nematic LC host at ˜20° C. and a right-handed chiral dopant R811 available from Merck KGaA under code name ZLI-3786 has an HTP of ˜11 μm⁻¹ in the same host and at the same temperature. Other example of chiral dopants are S-1011 (ZLI-4571) and R-1011 (ZLI-4572) available from Merck KGaA have higher HTP values and can be mixed in at lower concentrations. In one example of a PCNLC formulation, the components are mixed at the following weight percentages: E7 nematic LC at 75%, R811 or S811 chiral dopant at 13.5%, Irgacure651 photoinitiator at 1%, and a polymerizable reactive mesogen RM257 at 10.5%. The width of the infrared bandwidth affected can be increased by introducing a gradient into the pitch of the cholesteric coating. This gradient can be created during the UV-light polymerization of the PCNLC using a temperature gradient, a chiral concentration gradient, or UV-absorbers, such as fluorescent dye ADA4605 available from HW SandsCorp, by employing the Beer-Lambert law. All these conditions may facilitate a resulting gradient in monomer and/or chiral dopant concentrations during the polymerization process, which produces a varying cholesteric pitch across the final PCNLC layer. Widening of the infrared band gap can be also achieved by coating the substrate with multiple cholesteric layers having varying concentrations of chiral dopants from 0% to 99% by weight and thus with varying cholesteric pitch values.

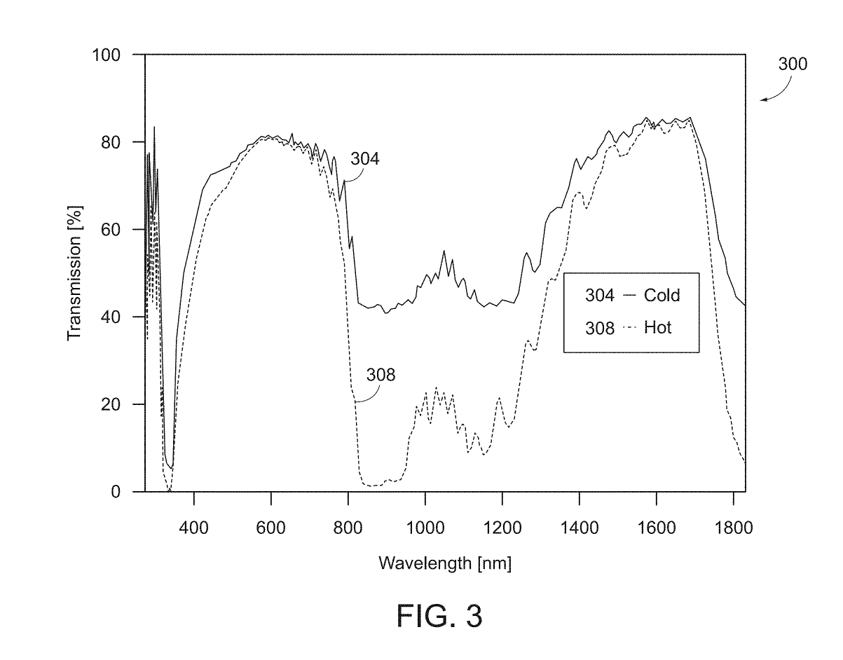

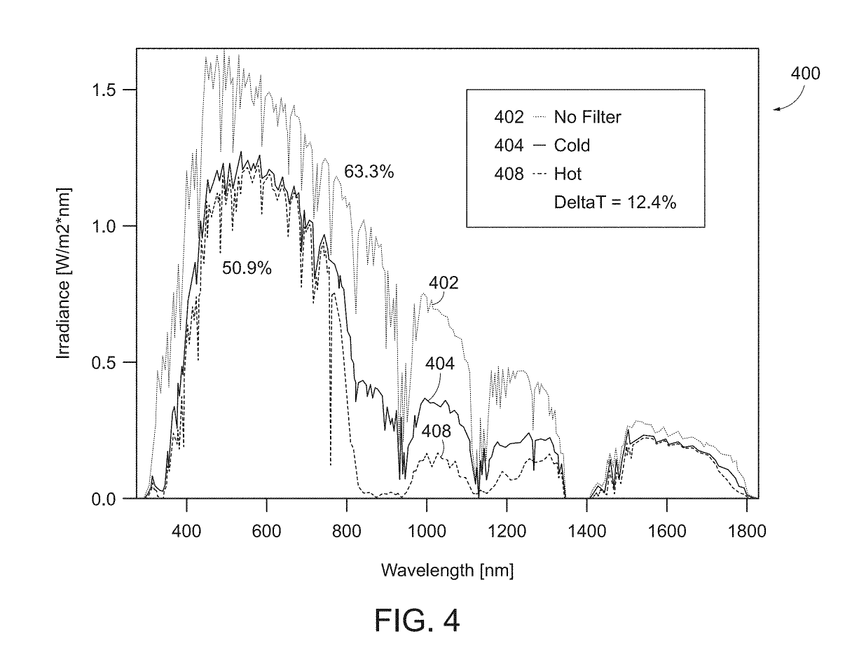

FIG. 3 is a graphical representation 300 of light transmittance through the filter assembly 200 illustrated in FIG. 2. As mentioned, the filter assembly 200 is made with cholesteric Bragg reflector coatings. In FIG. 3, the cold state (˜25° C.) transmittance is represented by a first curve, which is generally indicated with reference number 304. Hot state (>38° C.) transmittance is represented by a second curve, which is generally indicated with reference number 308. Other Tₙᵢ temperatures within the working temperature range can be chosen by tuning the NLC formulation. FIG. 4 is a graphical representation 400 of solar spectrum modulation through the filter assembly 200 illustrated in FIG. 2. As mentioned, the filter assembly 200 is made with cholesteric Bragg reflector coatings. In FIG. 4, cold state modulation (below Tₙᵢ temperature point) is represented by a first curve, which is generally indicated with reference number 404. Hot state modulation (above Tₙᵢ temperature point) is represented by a second curve, which is generally indicated with reference number 408. A third curve representing unfiltered light is generally indicated with reference number 402.

As can be seen in FIG. 3, transmittance is modulated in the infrared range of the spectrum of light. The shape of the transmittance curve of FIG. 3 defines a profile of the electromagnetic radiation that is transmitted by the filter assembly 200. As can be seen in FIG. 3, the near infrared range of filter profile falls in the range of ˜780 nm to ˜1280 nm. The exact profile of the light transmittance in the infrared range is not as important as in the case with the curves that span the visible range of light, where small changes in transmittance levels at different wavelengths lead to undesirable coloration of the resulting smart window. Infrared light is invisible to the human eye and does not contribute to undesired window hues. In other words, infrared light modulation is only important for providing energy efficiency (see FIG. 4), but not glare mitigation or color adjustment. This significantly simplifies the design requirements of smart window components that are responsible for infrared solar energy control.

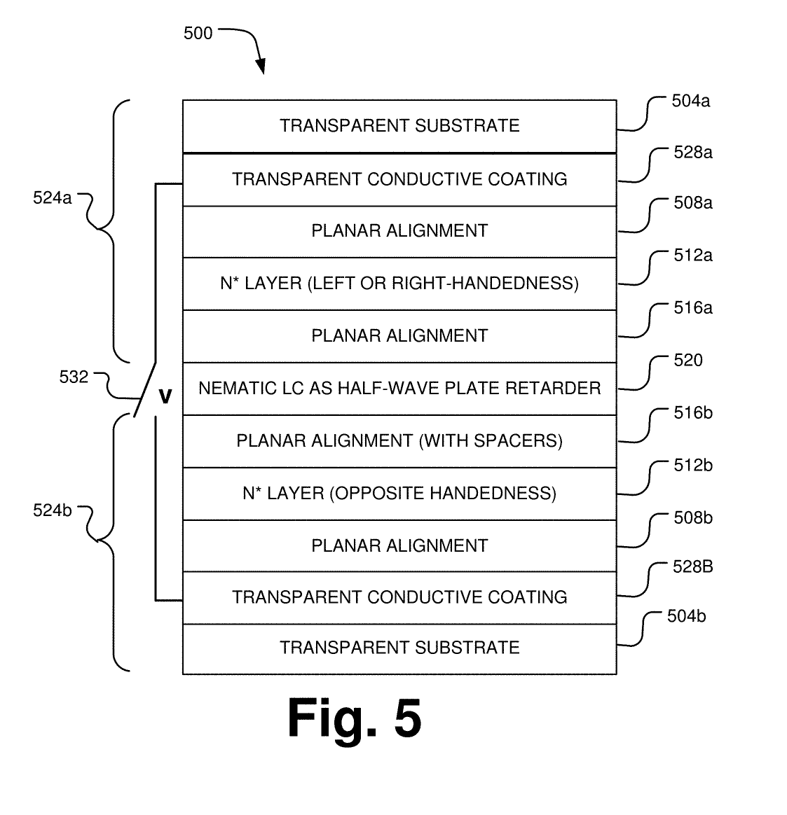

Dynamic infrared cholesteric Bragg reflectors in accordance with the present disclosure can be also used for smart windows that are electrically driven. FIG. 5 is a schematic illustration of a filter assembly 500 that includes cholesteric Bragg reflectors for electrically driven modulation of light in the infrared range of solar spectrum. The filter assembly 500 may include a first section 524a having layers corresponding to those described above in connection with FIG. 2. Specifically, the first section 524a may include a transparent substrate 504a, a liquid crystal alignment layer 508a, a PCNLC layer 512a, and a second liquid crystal alignment layer 516a. The first section 524a may enclose a first side of an inner NLC layer 520. The filter assembly 500 may also include a second section 524b having layers corresponding to those described above in connection with FIG. 2. Specifically, the second section 524b may include a transparent substrate 504b, a liquid crystal alignment layer 508b, a PCNLC layer 512b, and a second liquid crystal alignment layer 516b. The second section 524b may enclose a second side of the inner NLC layer 520.

Microspheres acting as spacers may be used to define a cell gap of the NLC layer 520. The spacing may be chosen according to the birefringence and central wavelength of the reflection band (i.e., the infrared bandwidth) such that the liquid crystal layer 520 acts as a half wave retarder. In one embodiment, the liquid crystal layer 520 acts as a half wave retarder of the 0^{th} order. These microspheres can be mixed with the liquid crystal or sprayed over or embedded on one of the alignment layers 516a-b for the inner NLC layer 520. Other spacing structures may also be used, for example, protrusions formed on and extending from sides of substrates or alignment layers.

In some respects, the layers of the filter assembly 500 of FIG. 5 are similar to the corresponding layers of the filter assembly 200 of FIG. 2. The transparent substrates 504a-b may function as mechanical carriers for additional layers and may form the window of a building, vehicle, or the like. The liquid crystal alignment layers 508a-b may be adhered, laminated, or otherwise coupled to the transparent substrates 504a-b and may be buffed to obtain a particular planar orientation of the liquid crystal molecules that are aligned by the alignment layers 508a-b. The PCNCL layers 512a-b may be sandwiched between the liquid crystal alignment layers 508a-b and 516a-b, respectively, and may be polymerized in order to preserve the chiral nematic state and pitch at working temperatures. The PCNLC layer 512a of the first section 524a may be of opposite handedness from that of the PCNLC layer 512b of the second section 524b. The second liquid crystal alignment layers 516a-b may be coupled to the PCNLC layer 512a-b, may provide homogenous alignment to liquid crystals, and may be buffed to obtain a particular planar orientation of the liquid crystal molecules that are aligned by the alignment layer 516a-b.

Filter assembly embodiments that are electrically driven may use a high clearing temperature (high Tₙᵢ) NLC half-wave retarder to modulate light entering the filter assembly. Thus, the NLC layer 520 shown in FIG. 5 differs from that of the NLC layer 220 shown in FIG. 2. Specifically, the NLC layer 520 of FIG. 5 is configured to have a clearing point outside of the temperature range in which filter assembly 500 operates, i.e., outside the working temperature range. More specifically, the NLC layer 520 of FIG. 5 has a nematic-isotropic temperature transition point (Tₙᵢ) above the highest temperature at which the filter assembly 500 is expected to operate. For example, a filter assembly 500 that is adapted for use in an environment having maximum temperatures around 120° Fahrenheit may have a NLC layer 520 with a clearing point of around 150° Fahrenheit or above. In this way, temperature changes that may occur during the operation of filter assembly 500 do not cause a transition from the nematic state to the isotropic state.

With the NLC layer 520 configured to be free of temperature induced nematic-isotropic transitions within a normal operating range, the filter assembly 500 may be configured for electrically induced transitions. In this regard, the electrically driven filter assembly 500 may be coated with one or more transparent electrically conducting layers 528a-b. The transparent electrically conducting layers 528a-b may be, for example, indium-tin oxide, silver nanowires, conducting polymers, or the like. The transparent electrically conducting layers 528a-b may be formed on the transparent substrate layers 504a-b. On an opposite side, the transparent electrically conducting layers 528a-b may be adhered, laminated, or otherwise coupled to the alignment layers 508a-b.

The transparent electrically conducting layers 528a-b may additionally be coupled to a voltage switch 532 that is configured to selectively apply a voltage to the transparent electrically conducting layers 528a-b so as to switch the filter assembly 500 between different transmittance states. In operation, the filter assembly may change transmittance amounts through changes to a voltage that is applied to the transparent electrically conducting layers. When voltage is not applied to the transparent electrically conducting layers, the nematic half-wave plate is in planar alignment and provides for polarization inversion. When sufficient voltage is applied to transparent electrically conducting layers, the nematic LC becomes homeotropically aligned by the electric field and the polarization inversion effect vanishes. The driving voltage may be reduced significantly if the conducting layers are applied over the polymerized PCNLC layers 512a-b instead, because this reduces the liquid crystal capacitor width by several microns, for example, by 10 microns if each PCNLC layer 512a-b with its alignment layer 508a-b is 5 microns thick.

The operation of the filter assembly 500 will now be described. Assuming that the PCNLC layer 512a (i.e., a near infrared cholesteric Bragg reflector) of the first section 524a is left-handed, half of the incident light is reflected or otherwise blocked as left-circularly polarized light. The other half is transmitted as right-circularly polarized light into the nematic LC half-wave plate 520. The half-wave plate 520 inverts the transmitted light into left-circular polarized light, which is then transmitted through the second right-handed PCNLC 512b of the second section 524b. Upon application of a voltage to the electrically conducting layers 528a-b through the voltage switch 532, the nematic director of the LC forming the half-wave plate 520 reorients to align with the electric field, perpendicular to the substrate plane. In this state, the transmitted right-circularly polarized light is no longer transformed into left-circularly polarized light and is thus reflected or otherwise blocked by the second right-handed PCNLC layer 512b of the second section 524b and no longer transmitted. Regardless of the state of the NLC half-wave plate 520, the visible light is transmitted through the assembly 500 substantially unimpeded.

Dynamic infrared cholesteric Bragg reflectors in accordance with the present disclosure can be also used for smart windows that integrate infrared and visible dynamic filters into a single Vis-IR filter. Filter assembly embodiments that implement a single Vis-IR filter may be used to mitigate sun glare as well as for thermal control. Sun glare is often inconvenient to occupants of buildings and for this reason it is desirable to incorporate infrared solar energy modulation with visible light modulation in a single smart window. Filter assembly embodiments that implement a single Vis-IR filter may use infrared dynamic control as described above in combination with other technologies that dynamically control visible light transmittance. Technologies that may be used to dynamically control visible light transmittance include guest-host (GH) devices employing positive or negative dichroic dyes (guest) in thermally or electrically switchable liquid crystal material (host), twisted NLC (TN) devices, and so on.

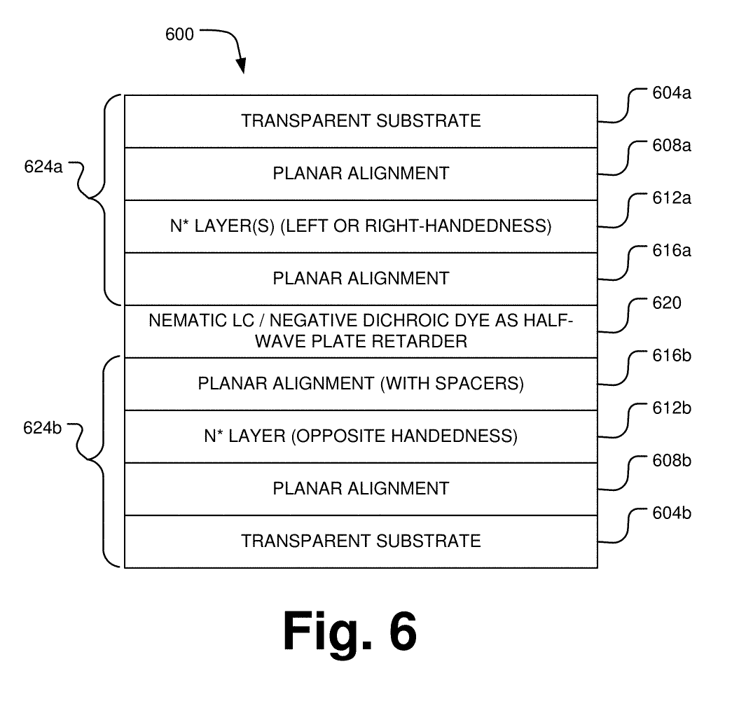

FIG. 6 is a schematic illustration of a filter assembly 600 that integrates infrared and visible dynamic filters into a single Vis-IR filter. The filter assembly 600 may include a first section 624a having layers corresponding to those described above in connection with FIG. 2. Specifically, the first section 624a may include a transparent substrate 604a, a liquid crystal alignment layer 608a, a PCNLC layer 612a, and a second liquid crystal alignment layer 616a. The first section 624a may bound a first side of the inner NLC layer 620. The filter assembly 600 may also include a second section 624b having layers corresponding to those described above in connection with FIG. 2. Specifically, the second section 624b may include a transparent substrate 604b, a liquid crystal alignment layer 608b, a PCNLC 612b, and a second liquid crystal alignment layer 616b. The second section 624b may bound a second side of the inner NLC layer 620 and, in conjunction with the first section 624a, thereby encapsulate the inner NLC layer 620.

Microspheres acting as spacers may be used to define a cell gap of the NLC layer 620. The spacing may be chosen according to the birefringence and central wavelength of the reflection band (i.e., the infrared bandwidth) such that the liquid crystal layer 620 acts as a half wave retarder. In one embodiment, the liquid crystal layer 620 acts as a half wave retarder of the 0^{th} order. These microspheres can be mixed with the liquid crystal or sprayed over or embedded on one of the alignment layers 616a-b for the inner NLC layer 620. Other spacing structures may also be used, for example, protrusions formed on and extending from sides of substrates or alignment layers.

In some respects, the layers of the filter assembly 600 of FIG. 6 are similar to the corresponding layers of the filter assembly 200 of FIG. 2. The transparent substrates 604a-b may function as mechanical carriers for additional layers and may form the window of a building, vehicle, or the like. The liquid crystal alignment layers 608a-b may be adhered, laminated, or otherwise coupled to the transparent substrates 604a-b and may be buffed to obtain a particular planar orientation of the liquid crystal molecules that are aligned by the alignment layers 608a-b. The PCNLC layers 612a-b may be coupled to the liquid crystal alignment layer 608a-b and may be polymerized in order to preserve its chiral nematic state and pitch at working temperatures. The PCNLC layer 612a of the first section 624a may be of opposite handedness from that of the PCNLC layer 612b of the second section 624b. The second liquid crystal alignment layers 616a-b may be coupled to the PCNLC layers 612a-b, may provide homogenous alignment to liquid crystals, and may be buffed to obtain a particular planar orientation of the liquid crystal molecules that are aligned by the alignment layer 616a-b.

The system illustrated in FIG. 6 is based on combining of the infrared cholesteric Bragg reflectors with negative dichroic dyes in liquid crystals guest-host formulation that is also functioning as a thermotropic half-wave plate retarder. Infrared light modulation is controlled by the cholesteric Bragg reflectors 612a-b in combination with the thermotropic half-wave plate 620. Visible light modulation is controlled by one or more negative dichroic dyes, also known as T-type dyes, such as 1-Alkylbenzoylamino-4-alkylbenxoyl-oxyanthraquinone, 1,8-diaroylamino-4,5-dialkylaminoanthraquinone, and the like. As shown in FIG. 6, the negative dichroic dye may be included in the NLC layer 620. The amount of infrared light reflection is determined by the pitch gradient (infrared band gap width) and by the thickness of the cholesteric coatings. The thickness of the dichroic dye liquid crystal layer is restricted by the half-wave plate 620, since a specific width of the retarder is required for maintaining the half-wave plate property for infrared light modulation. For example, if the thickness of the NLC layer 620 needs to be increased due to a need to add dichroic dye, then the birefringence value of the NLC needs to be decreased by selecting a different type of NLC. Thus, the amount of visible light modulation can be controlled by tuning the concentrations of negative dichroic dyes.

The operation of the filter assembly 600 will now be described. Assuming that the PCNLC layer 612a (e.g., a cholesteric Bragg reflector) of the first section 624a is left-handed, half of the incident light is reflected or otherwise blocked as left-circularly polarized light. The other half is transmitted as right-circularly polarized light into the nematic half-wave plate 620. The half-wave plate 620 inverts the transmitted light into left-circular polarized light, which is then transmitted through the second right-handed PCNLC layer 612b of the second section 624b. In this state, the NLC half-wave plate 620 orients the negative dichroic dye into a direction that allows light in the visible spectrum to pass through the filter assembly 600. This is possible because the dye molecules are planar aligned by the nematic LC of the half-wave retarder 620 and because these molecules possess the property of negative circular dichroism. When the temperature of the filter assembly 600 rises above the clearing point, the half-wave plate 620 transitions to its isotropic state and the half-wave plate function vanishes. In this state, the transmitted infrared, right-circularly polarized light is no longer inverted into left-circularly polarized light and is thus reflected or otherwise blocked by the second right-handed PCNLC layer 612b of the second section 624b. Additionally, in this state, the nematic LC host in the half-wave plate retarder 620 orients the negative dichroic dye molecules randomly, which causes the visible light to be substantially absorbed, preventing this light from passing through the filter assembly 600.

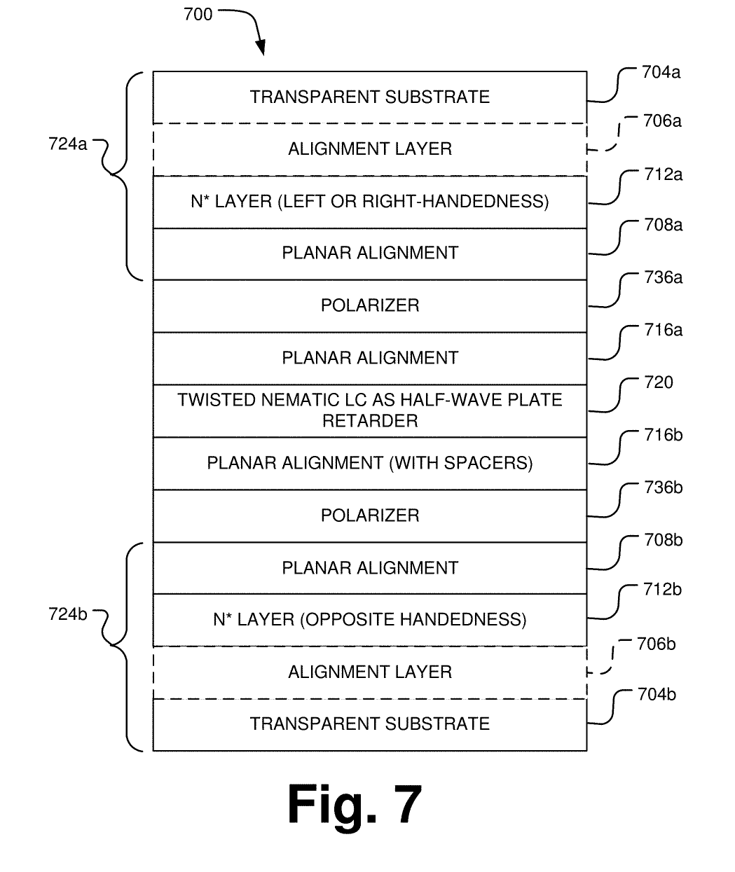

FIG. 7 is a schematic illustration of an alternative filter assembly 700 embodiment that integrates infrared and visible dynamic filters into a single Vis-IR filter. The filter assembly 700 may include a first section 724a having layers corresponding to those described above in connection with FIG. 2. Specifically, the first section 724a may include a transparent substrate 704a, an optional alignment layer 706a, a PCNLC layer 712a, a liquid crystal alignment layer 708a, a linear polarizer film layer 736a, and a second liquid crystal alignment layer 716a. The filter assembly 700 may also include a second section 724b having layers corresponding to those described above in connection with FIG. 2. Specifically, the second section 724b may include a transparent substrate 704b, an optional alignment layer 706b, a PCNLC layer 712b, a liquid crystal alignment layer 708b, a polarizer film layer 736b, and a second liquid crystal alignment layer 716b. An inner NLC layer 720 may be sandwiched between the first section 724a and the second section 724b.

Microspheres acting as spacers may be used to define a cell gap of the NLC layer 720. The spacing may be chosen according to the birefringence and central wavelength of the reflection band (i.e., the infrared bandwidth) such that the NLC layer 720 acts as a half-wave retarder in association with PCNLC layers 712a and 712b. In one embodiment, the NLC layer 720 acts as a half-wave retarder of the 0^{th} order. These microspheres can be mixed with the liquid crystal or sprayed over or embedded on one of the alignment layers 716a-b for the inner NLC layer 720. Other spacing structures may also be used, for example, protrusions formed on and extending from sides of substrates or alignment layers.

In some respects, the layers of the filter assembly 700 of FIG. 7 are similar to the corresponding layers of the filter assembly 200 of FIG. 2. The transparent substrates 704a-b may function as mechanical carriers for additional layers and may form the window of a building, vehicle, or the like. The liquid crystal alignment layers 708a-b may be buffed to obtain a particular planar orientation of the liquid crystal molecules that are aligned by the alignment layers 708a-b. The PCNLC layers 712a-b may be deposited on the liquid crystal alignment layers 708a-b and may be polymerized in order to preserve its chiral nematic state and pitch at working temperatures. The PCNLC layer 712a of the first section 724a may be of opposite handedness from that of the PCNLC layer 712b of the second section 724b.

The coated liquid crystal alignment layers 708a-b may be adhered, bonded, or laminated to the transparent substrates 704a-b with the PCNLC layers 712a-b adjacent to the transparent substrates 704a-b. The linear polarizer film layers 736a-b are bonded to the opposite sides of the liquid crystal alignment layers 708a-b and are rotated by a predetermined angle with respect to each other, which determines how much of the visible light is blocked. The angle of the molecular rotation of the twisted NLC of the PCNLC layer 720 (half-wave plate) is designed to be the same as the angle between the polarizing directions of linear polarizers 736a and 736b. The PCNLC layers 712a-b should be coated on the outside of the polarizer film layers 736a-b as shown in FIG. 7. Otherwise the birefringent cholesteric layers can cause bright colors to appear when placed between the linear polarizers. The second liquid crystal alignment layers 716a-b may be placed on the polarizer film layers 736a-b and the inner NLC layer 720 may be encapsulated between them. The second liquid crystal alignment layers 716a-b may be buffed to provide homogenous linear alignment of the liquid crystal molecules.

The system illustrated in FIG. 7 is based on combining infrared modulation capability based on N* Bragg reflectors with a visible light filter made with linear polarizers 736a-b that are crossed at a predetermined angle depending on desirable amount of visible light transmittance. Infrared light modulation is controlled by the cholesteric Bragg reflectors 712a-b in combination with 720 creating a thermotropic half-wave plate. Visible light modulation is controlled by the twisted NLC configuration 720 combined with linear polarizer layers 736a-b. As shown in FIG. 7, the filter assembly 700 may include linear polarizer layers 736a-b that are arranged on opposing sides of a twisted NLC layer 720. The polarizer layers 736a-b may be arranged in a crosswise orientation such that the polarizing direction of the first polarizing layer 736a is oriented by an angle θ of a value anywhere between parallel to perpendicular to that of the second polarizing layer 736b. The twisted NLC layer 720 may be accordingly configured to rotate incoming light by the same angle θ as chosen between polarizing axes of 736a-b when the liquid crystal in the twisted NLC layer 720 is in the nematic state.

The molecules in a nematic LC are all oriented in the same direction along a chosen axis, typically determined by the buffing direction in the first alignment layer 716a. In order to create a twist of these molecules a small amount of chiral dopant is added and typically the direction of the second alignment layer 716b is rotated as well with respect to the first alignment layer 716a to correspond to the twist angle of the twisted nematic LC. When a large amount of chiral dopant is added to the nematic LC or the chiral dopant has a very large twisting power, then the twist of the nematic LC assumes a large number of full rotations within the cell gap. Such nematic liquid crystal is no longer termed twisted, but is referred to as cholesteric or chiral instead.

The twist angle of NLC molecules in the twisted NLC layer 720 can be increased further by adding n multiples of half-rotations (180°) to realize the super twisted nematic (STN) mode (θ+n*180°) for preserving color neutrality of the filter assembly 700 at various angles with respect to the normal of the stack plane. The number of multiples n is typically small, e.g., n=0, 1, 2; otherwise, if n is a large number, nematic LC becomes cholesteric. In this way, the twisted (or super-twisted) NLC layer 720 may rotate the light from the polarizing direction of the first polarizer 736a to the polarizing direction of the second polarizer 736b. When the twisted NLC layer 720 is in the isotropic state, visible light may pass through the NLC layer 720 without being rotated and thus substantially absorbed by the second linear polarizer according to the chosen crossing angle θ between the polarizers 736a-b.

The operation of the filter assembly 700 will now be described. First, the visible dynamic filter portion of the filter assembly 700 will be described. Assuming that the first linear polarizer 736a polarizes light in a first direction, half of the incident light is reflected or absorbed (depending upon whether the polarizer films 736a-b are reflective or absorptive) as light polarized in the first direction. The other half is transmitted as light polarized in a second direction into the twisted NLC layer 720. Here, the first direction is oriented at an angle of degrees with respect to the second direction of second linear polarizer 736b. The twisted NLC layer 720 rotates the transmitted linearly polarized light by θ (TN-mode) or θ+n*180 (STN-mode), which is then transmitted without reflection or absorption through the second polarizer 736b. When the temperature of filter assembly rises above the clearing point of the NLC layer 720, the twisted NLC layer 720 transitions to its isotropic state and the light's polarization rotating function vanishes. In this state, the transmitted light polarized in the first direction is no longer rotated into light polarized in the second direction and is thus reflected or absorbed by the second polarizer 736b and no longer transmitted. Complete reflection or absorption of the visible light by the second polarizer 736b is achieved if 6=90° when the first and second linear polarizers 736a-b have their polarizing axes oriented strictly perpendicular to each other.

The infrared dynamic filter portion 724a-b of the filter assembly 700 will now be described. Assuming that the PCNLC layer 712a (e.g., a cholesteric Bragg reflector) of the first section 724a is left-handed, half of the incident infrared light is reflected or otherwise blocked as left-circularly polarized infrared light. The other half is transmitted as right-circularly polarized infrared light into the NLC layer 720, which functions as a half-wave plate with designed maximum efficiency at the middle of the infrared band gap spanned by the PCNLC layers 712a-b. It may also be noted that the wavelength of infrared light is not affected by the linear polarizers 736a-b. Due to wavelength dispersion, the quality of inversion is not the same at all wavelengths and thus the thickness of the half-wave plate may be tuned such that the inversion quality is at its maximum in the middle of the cholesteric Bragg reflector band gap. The 0-th order half wave plate provides for the widest span of wavelengths for polarization inversion. The NLC layer 720 inverts the transmitted infrared light into left-circular polarized infrared light, which is then transmitted through the second right-handed PCNLC layer 712b of the second section 724b. When the temperature of filter assembly rises above the clearing point, the half-wave plate 720 transitions to its isotropic state and the half-wave plate function vanishes. In this state, the transmitted right-circularly polarized infrared light is no longer transformed into left-circularly polarized infrared light and is thus reflected or otherwise blocked by the second right-handed PCNLC layer 712b of the second section 724b, but no longer transmitted. As noted in above with other embodiments, visible light is substantially unimpeded by the dynamic filter portion 724a-b.

This configuration prevents the birefringent cholesteric PCNLC layers 712a-b from causing bright colors to appear, an undesirable side effect that might otherwise occur if the cholesteric PCNLC layers 712a-b were placed between the polarizers 736a-b. The polarizers 736a-b themselves may introduce some birefringence, which can cause negative effects on infrared light modulation capability provided by the N* Bragg reflectors. In this case, the birefringence that arises from polarizers can be canceled out by incorporating a negative birefringence compensation film anywhere between the outer layer cholesteric coatings.

Embodiments in accordance with the present disclosure may also include filter assemblies that include cholesteric N* Bragg reflectors with thermotropic half-wave plate and a guest host (GH) system based on positive dichroism. The guest dichroic dye may be included to provide additional visible light absorbing properties to the stack. It is generally not feasible to use a dichroic dye liquid crystal formulation based on positive dichroism in conjunction with a thermotropic half-wave plate function of the same NLC layer because positive dichroic dyes require homeotropic alignment in the clear state and the half-wave retarder requires the liquid crystal dye system to have some birefringence Δn, which equals 0 in the case of homeotropic alignment. In order to avoid this difficulty, present embodiments provide separate filter stacks for the infrared and visible ranges of radiation. The separate filter stacks may be interconnected or otherwise arranged in an adjacent configuration. For example, a filter assembly embodiment may use a cholesteric infrared filter and dichroic dye liquid crystal filter based on positive dichroism separately in the same insulated glass unit.

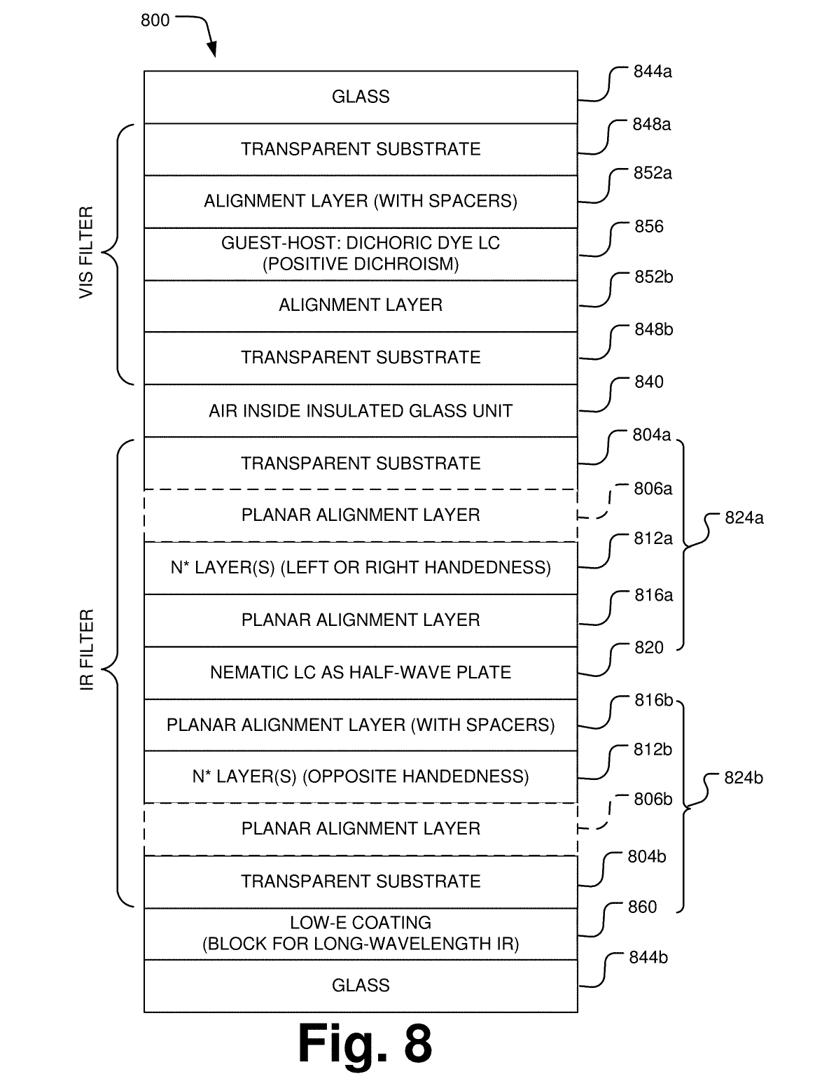

FIG. 8 is a schematic illustration of a filter assembly 800 that integrates infrared and visible dynamic filters into a single Vis-IR filter. The filter assembly 800 may include a first section 824a having layers substantially corresponding to those described above in connection with FIG. 2. Specifically, the first section 824a may include a transparent substrate 804a, a PCNLC layer 812a, and a liquid crystal alignment layer 816a. The first section 824a may be a first encapsulating side for an inner NLC layer 820. The filter assembly 800 may also include a second section 824b having layers substantially corresponding to those described above in connection with FIG. 2. Specifically, the second section 824b may include a transparent substrate 804b, a PCNLC layer 812b, and a liquid crystal alignment layer 816b. The second section 824b may be positioned opposite to a second side of the inner NLC layer 820 and coupled to the first section 824a to encapsulate the NLC layer 820.

Microspheres acting as spacers may be used to define a cell gap of the NLC layer 820. The spacing may be chosen according to the birefringence and central wavelength of the reflection band (i.e., the infrared bandwidth) such that the liquid crystal layer 820 acts as a half wave retarder. In one embodiment, the liquid crystal layer 820 acts as a half wave retarder of the 0^{th} order. These microspheres can be mixed with the liquid crystal or sprayed over or embedded on one of the alignment layers 816a-b for the inner NLC layer 820. Other spacing structures may also be used, for example, protrusions formed on and extending from sides of substrates or alignment layers.

In some respects, the layers of the filter assembly 800 of FIG. 8 are similar to the corresponding layers of the filter assembly 200 of FIG. 2. The transparent substrates 804a-b may function as mechanical carriers for additional layers and may form the window of a building, vehicle, or the like. The PCNLC layers 812a-b may be sandwiched between respective transparent substrates 804a-b and liquid crystal alignment layer 816a-b and may be polymerized in order to preserve its chiral nematic state and pitch at working temperatures. The liquid crystal alignment layers 816a-b may be buffed to obtain a particular planar orientation and provide homogenous alignment of the liquid crystal molecules that are aligned by the alignment layers 816a-b. The PCNLC layer 812a of the first section 824a may be of opposite handedness from that of the PCNLC layer 812b of the second section 824b.

The system illustrated in FIG. 8 is based on combining two separate filter stacks. Infrared light modulation is controlled through the filter stack described above, i.e., by the cholesteric Bragg reflectors 812a-b in combination with the thermotropic half-wave plate 820. Visible light modulation is controlled with a second filter stack using one or more positive dichroic dyes in a liquid crystal guest-host formulation. However, the visible light filter (using positive dichroic dyes) and the infrared light filter (using N* Bragg reflectors) may be integrated together within the same insulated glass unit 840.

As shown in FIG. 8, the visible light filter portion of the filter assembly 800 may include first and second transparent substrates 848a-b that function as mechanical carriers for additional layers. Liquid crystal alignment layers 852a-b may be adhered, laminated, bonded, or otherwise coupled to the transparent substrates 848a-b and may be buffed to obtain a particular homeotropic orientation of the liquid crystal molecules that are aligned by the alignment layers 852a-b. A liquid crystal layer 856 may be contained between the liquid crystal alignment layers 852a-b. Microspheres acting as spacers may be used to define a cell gap of the liquid crystal layer 856. These microspheres can be mixed with the liquid crystal or sprayed over or embedded on one of the alignment layers 852a-b for the liquid crystal layer 856. Other spacing structures may also be used, for example, protrusions formed on and extending from sides of substrates or alignment layers 852a-b. The liquid crystal layer 856 may include a positive dichroic dye that is configured to be oriented into different directions depending on the nematic or isotropic phase of the liquid crystal layer 856. An example of a black mixture of positive dichroic dye formulation is commercially available from Mitsui Chemicals under trade name “Black S-428”. Another example of a formulation of a positive black dichroic dye is described in U.S. Pat. No. 9,057,020.

The operation of the filter assembly 800 will now be described. When below the clearing point temperature, in the visible layer stack the liquid crystal 856 keeps the positive dichroic dye in an orientation that allows light in the visible spectrum to pass through the filter assembly 800 substantially unimpeded because the long molecular axes of the anisotropic dyes are aligned with the direction of host NLC molecules, which are aligned in the same direction of light propagation. The infrared light passes through the visible layer stack without impediment. Assuming that the PCNLC layer 812a (i.e., the cholesteric Bragg reflector) of the first section 584a is left-handed, half of the incident infrared light is reflected or otherwise blocked as left-circularly polarized light. The other half of the infrared light is transmitted as right-circularly polarized light into the nematic half-wave plate 800. The half-wave plate 820 inverts the transmitted infrared light into left-circular polarized infrared light, which is then transmitted through the second right-handed PCNLC layer 812b of the second section 824b. The visible light passes through the infrared layer stack without impediment.

When the temperature of filter assembly rises above the clearing point, the liquid crystal 856 transitions to its isotropic state that randomly orients the positive dichroic dye molecules. This causes the dye to absorb or otherwise block visible light of a particular range of wavelengths, preventing visible light from passing through the filter assembly 800. The efficiency of visible light absorption is controlled by the dichroic ratio of the chosen dye and by the concentration of guest dyes in host NLC. In the infrared filter stack, the half-wave plate 820 transitions to its isotropic state and the half-wave plate function vanishes. In this state, the transmitted right-circularly polarized infrared light is no longer transformed into left-circularly polarized infrared light and is thus reflected or otherwise blocked by the second right-handed PCNLC layer 812b of the second section 824b, but no longer transmitted.

The dichroic dye liquid crystal visible light filter can be adhered to the inside of the glass 844a that faces toward the outside of a building, also known as “surface 2” of a two pane insulated glass unit. The cholesteric infrared filter can be adhered to the inside of the second glass pane 844b on top of a low emissivity (Low-E) coating 860, also known as “surface 3” of a two pane insulated glass unit. The function of the Low-E coating 860 here is to pass the solar near infrared (NIR) light, but block the long wavelength infrared light that is generated by heated layers and objects inside and outside the building. This Low-E coating for selectively rejecting long infrared wavelengths can be incorporated anywhere after the absorptive system, e.g., coated onto the transparent substrates of the filter 800 or other layers.

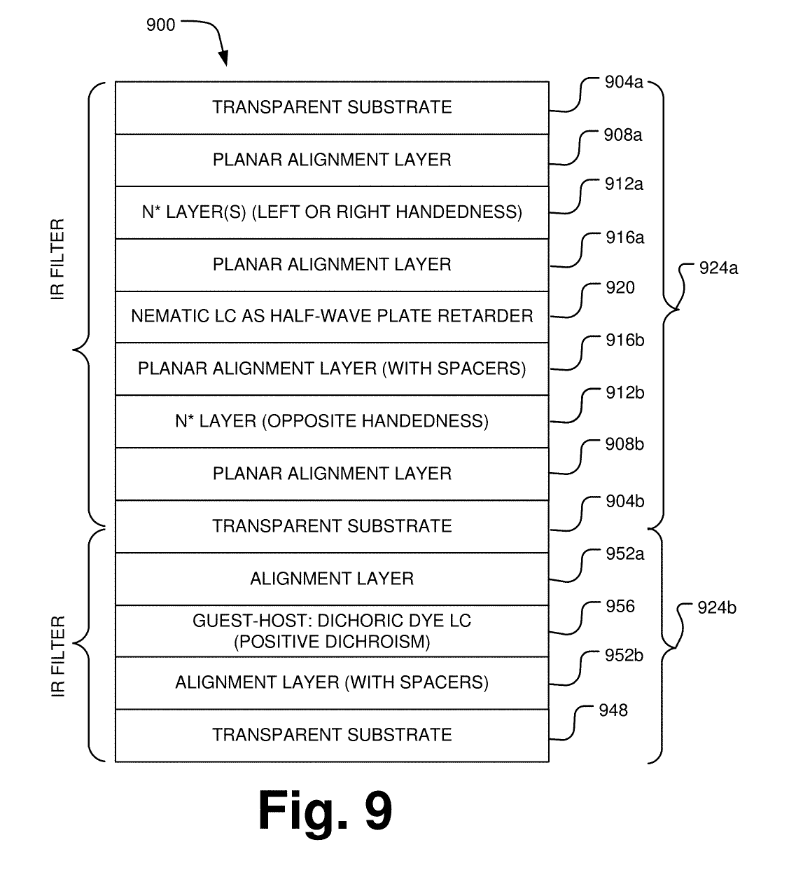

FIG. 9 is a schematic illustration of an alternative filter assembly 900 that integrates infrared and visible dynamic filters into a single Vis-IR filter. The filter assembly 900 may include a first section 924a having layers corresponding to those described above in connection with FIG. 2. Specifically, the first section 924a may include a transparent substrate 904a, a liquid crystal alignment layer 908a, a PCNLC layer 912a, and a second liquid crystal alignment layer 916a. The first section 924a may be bound to a first side of the inner NLC layer 920. The filter assembly 900 may also include a second section 924b having layers corresponding to those described above in connection with FIG. 2. Specifically, the second section 924b may include a transparent substrate 904b, a liquid crystal alignment layer 908b, a PCNLC layer 912b, and a second liquid crystal alignment layer 916b. The second section 924b may be positioned opposite to a second side of the inner NLC layer 920 and coupled to the first section 924a to encapsulate the NLC layer 920.

Microspheres acting as spacers may be used to define a cell gap of the NLC layer 920. The spacing may be chosen according to the birefringence and central wavelength of the reflection band (i.e., the infrared bandwidth) such that the liquid crystal layer 920 acts as a half wave retarder. In one embodiment, the liquid crystal layer 920 acts as a half wave retarder of the 0^{th} order. These microspheres can be mixed with the liquid crystal or sprayed over or embedded on one of the alignment layers 916a-b for the inner NLC layer 920. Other spacing structures may also be used, for example, protrusions formed on and extending from sides of substrates or alignment layers.

In some respects, the layers of the filter assembly 900 of FIG. 9 are similar to the corresponding layers of the filter assembly 200 of FIG. 2. The transparent substrates 904a-b may function as a mechanical carriers for additional layers and may form the window of a building, vehicle, or the like. The liquid crystal alignment layers 908a-b may be adhered, laminated, bonded, or otherwise coupled to the transparent substrates 904a-b and may be buffed to obtain a particular planar orientation of the liquid crystal molecules that are aligned by the alignment layers 908a-b. The PCNLC layers 912a-b may be encapsulated within the liquid crystal alignment layers 908a-b and may be polymerized in order to preserve a chiral nematic state and pitch at working temperatures. The PCNLC layer 912a of the first section 924a may be of opposite handedness from that of the PCNLC layer 912b of the second section 924b. The second liquid crystal alignment layers 916a-b may be bonded to the PCNLC layer 912a-b, may provide homogenous alignment to liquid crystals, and may be buffed to obtain a particular planar orientation of the liquid crystal molecules that are aligned by the alignment layer 916a-b.

The system illustrated in FIG. 9 is based on combining of the cholesteric Bragg reflectors with positive dichroic dyes in liquid crystals guest-host formulation. Infrared light modulation is controlled by the cholesteric Bragg reflectors 912a-b in combination with the thermotropic half-wave plate 920. Visible light modulation is controlled by one or more positive dichroic dyes. As shown in FIG. 9, the positive dichroic dye may be included in different NLC layer 956 from that of the NLC 920 layer. The filter assembly 900 combines visible and infrared filters into a single filter by using a common substrate in between the two filter stacks. The common substrate is generally referred to with reference number 904b. The visible light filter portion of the filter assembly 900 may include an additional transparent substrate 948 that functions as a mechanical carrier for additional layers. Liquid crystal alignment layers 952a-b may be adhered, bonded, laminated, or otherwise coupled to the transparent substrates 904b, 948, respectively, and may be buffed to obtain a particular homeotropic orientation of the liquid crystal molecules that are aligned by the alignment layers 952a-b. A second liquid crystal layer 956 may be encapsulated between the liquid crystal alignment layers 952a-b. The second liquid crystal layer 956 may include a positive dichroic dye that is configured to align into different orientations depending on the nematic or isotropic phase of the second liquid crystal layer 956.

The operation of the filter assembly 900 will now be described. Assuming that the PCNLC layer 912a (cholesteric Bragg reflector) of the first section 924a is left-handed, half of the incident infrared light is reflected or otherwise blocked as left-circularly polarized light. The other half is transmitted as right-circularly polarized infrared light into the nematic half-wave plate 900. The NLC layer 920 functions as a half-wave plate and inverts the transmitted infrared light into left-circular polarized light, which is then transmitted without reflection through the second right-handed PCNLC layer 912b of the second section 924b. Visible light passes through the PCNLC layers 912a-b substantially unaffected. Additionally, below the clearing point temperature, the second liquid crystal layer 956 arranges the positive dichroic dye into an orientation that allows light in the visible spectrum to pass through the filter assembly 900. Infrared light will pass through the guest-host layer unimpeded as typical dichroic dye formulations are capable of absorbing the light only within the visible spectrum. When the temperature of the filter assembly 900 rises above the clearing point, the NLC layer 920 transitions to its isotropic state and the half-wave plate function vanishes. In this state, the transmitted right-circularly polarized infrared light is no longer transformed into left-circularly polarized infrared light and is thus reflected or otherwise blocked by the second right-handed PCNLC layer 912b of the first section 924a and no longer transmitted. Additionally, the liquid crystal layer 956 transitions to an isotropic phase and reorients the positive dichroic dye into an orientation that reflects visible light wavelengths, preventing visible light from passing through the filter assembly 900.

Other approaches for dynamic solar infrared energy control in accordance with the present disclosure include dynamic control of visible and solar near-infrared (NIR) light using dichroic dyes. Dichroic dye formulations can be further enhanced by introducing additional near-infrared (NIR) dichroic dyes. Examples of near-infrared (NIR) dichroic dyes include metal complex dyes, phtalocyanine derivative dyes, and so on. These dyes widen the absorption band of wavelengths toward near-infrared solar radiation, thus increase the energy efficiency of a window that additionally contains such dyes.

Some embodiments in accordance with the present disclosure incorporate near-infrared dyes into the same liquid crystal host that already contains dichroic dyes that absorb in the visible range of the solar spectrum. In accordance with other embodiments, a separate filter based on near infrared dyes can be introduced into a smart window insulated glass unit that already contains a dichroic dye liquid crystal filter for managing of visible light transmittance. Here, the separate filter may be introduced in a case where the near-infrared dyes are poorly soluble in the presence of other dyes or if a different liquid crystal host formulation is required.

Another approach for dynamic solar infrared energy control in accordance with the present disclosure includes up-conversion of near infrared light. This approach to gaining access to the infrared portion of the solar spectrum includes converting the infrared photons into visible light photons. This approach may use dye-sensitized lanthanide ion nanoparticles or the like. This process is generally referred to as “up-conversion.” In up-conversion, two or more photons from the infrared spectrum (low energy photons) are absorbed by dye-sensitized nanoparticles and are converted into a single photon that belongs to the visible portion of the spectrum (i.e., a higher energy photon). An up-converting layer can be coated on a transparent substrate before the light enters into the guest-host dichroic dye liquid crystal formulation. The near infrared up-converting layer may be coated on the substrate and the homeotropic or planar alignment layer coated on top of the near infrared up-converting layer.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

The foregoing description has broad application. The discussion of any embodiment is meant only to be explanatory and is not intended to suggest that the scope of the disclosure, including the claims, is limited to these examples. In other words, while illustrative embodiments of the disclosure have been described in detail herein, the inventive concepts may be otherwise variously embodied and employed, and the appended claims are intended to be construed to include such variations, except as limited by the prior art.

What is claimed is:

1. A filter assembly, comprising:
a first chiral nematic liquid crystal layer having a first handedness;
a second chiral nematic liquid crystal layer having a second handedness; and
a nematic liquid crystal layer having a nematic-isotropic clearing point temperature chosen to be within the working temperature of the filter positioned between the first and second chiral nematic liquid crystal layers; wherein
in the nematic state,
the first chiral nematic liquid crystal layer blocks a first half of infrared light incident on the filter as infrared light of a first circular polarization and transmits a second half of the incident infrared light as polarized light of a second circular polarization to the nematic liquid crystal layer; and
the nematic liquid crystal layer functions as a half wave plate and inverts the transmitted infrared light into light of the first circular polarization, which is then transmitted through the second chiral nematic liquid crystal layer; and
in the isotropic state,
the first chiral nematic liquid crystal layer blocks a first half of infrared light incident on the filter as light of a first circular polarization and transmits a second half of the incident infrared light as polarized light of a second circular polarization to the nematic liquid crystal layer; and
the half-wave plate function of the nematic liquid crystal layer vanishes and the transmitted infrared light is blocked by the second chiral nematic liquid crystal layer as infrared light of a second circular polarization.

2. The filter assembly of claim 1, further comprising a transparent substrate that functions as a mechanical carrier for at least the first chiral nematic liquid crystal layer.

3. The filter assembly of claim 1, further comprising an alignment layer.

4. The filter assembly of claim 3, wherein the alignment layer is coupled to the first chiral nematic liquid crystal layer.

5. The filter assembly of claim 3, wherein the alignment layer is coupled to the nematic liquid crystal layer.

6. The filter assembly of claim 1, further comprising microspheres that act as spacers to define a cell gap of the nematic liquid crystal layer.

7. The filter assembly of claim 6, wherein the microspheres create a spacing that defines a retardation and central wavelength of a reflection band such that the nematic liquid crystal layer acts as a half wave plate of the 0^{th} order.

8. The filter assembly of claim 6, wherein the microspheres are embedded in alignment layer associated with the nematic liquid crystal layer.

9. The filter assembly of claim 1, wherein the filter is configured to filter infrared radiation.

10. The filter assembly of claim 1, further comprising a negative dichroic dye for filtering radiation in the visible spectrum.

11. The filter assembly of claim 1, further comprising a first linear polarizer, a second linear polarizer, and twisted nematic liquid crystal for filtering radiation in the visible spectrum.

12. The filter assembly of claim 1, wherein the first chiral nematic liquid crystal layer, the second chiral nematic liquid crystal layer, and the nematic liquid crystal layer form an infrared filtering stack, the filter assembly further comprising a visible spectrum stack having a positive dichroic dye.

13. The filter assembly of claim 12, wherein the infrared filtering stack and the visible spectrum filtering stack are integrated in a common insulated glass unit.

14. The filter assembly of claim 12, wherein the infrared filtering stack and the visible spectrum filtering stack share a common substrate.

15. A filter assembly, comprising:
a first chiral nematic liquid crystal layer having a first handedness;
a second chiral nematic liquid crystal layer having a second handedness; and
a nematic liquid crystal layer having a nematic-isotropic clearing point temperature chosen to be outside of the working temperature of the filter positioned between the first and second chiral nematic liquid crystal layers;
a transparent conducting layer positioned adjacent to the nematic liquid crystal layer; wherein
in a first voltage state applied to the transparent conducting layer,
the first chiral nematic liquid crystal layer blocks a first half of infrared light incident on the filter as light of a first circular polarization and transmits a second half of the incident infrared light as polarized infrared light of a second circular polarization to the nematic liquid crystal layer; and
the nematic liquid crystal layer functions as a half wave plate and inverts the transmitted infrared light into infrared light of the first circular polarization, which is then transmitted through the second chiral nematic liquid crystal layer; and
in a second voltage state applied to the transparent conducting layer,
the first chiral nematic liquid crystal layer blocks a first half of infrared light incident on the filter as infrared light of a first circular polarization and transmits a second half of the incident infrared light as polarized infrared light of a second circular polarization to the nematic liquid crystal layer; and
the half-wave plate function of the nematic liquid crystal layer vanishes and the transmitted infrared light is blocked by the second chiral nematic liquid crystal layer as infrared light of a second circular polarization.

16. The filter assembly of claim 15, further comprising a transparent substrate that functions as a mechanical carrier for at least the first chiral nematic liquid crystal layer.

17. The filter assembly of claim 15, further comprising an alignment layer.

18. The filter assembly of claim 17, wherein the alignment layer is coupled to the first chiral nematic liquid crystal layer.

19. The filter assembly of claim 17, wherein the alignment layer is coupled to the nematic liquid crystal layer.

20. The filter assembly of claim 15, further comprising microspheres that act as spacers to define a cell gap of the nematic liquid crystal layer.
